(19) United States
(12) Patent Application Publication
(10) Pub. No.: US 2017/0118631 A1
(43) Pub. Date: Apr. 27, 2017

(54) PRE-FETCH SCHEDULER FOR MULTI-STATION BASIC SERVICE SET (BSS)

(71) Applicant: QUALCOMM INCORPORATED, San Diego, CA (US)

(72) Inventors: Chao ZOU, San Jose, CA (US); Guido Robert FREDERIKS, Watsonville, CA (US); Srinivas KATAR, Freemont, CA (US); Xiaolong HUANG, Morgan Hill, CA (US); Qinghai GAO, Sunnyvale, CA (US); Naveen GANGADHARAN, San Jose, CA (US); Nathaniel David HOUGHTON, San Jose, CA (US); BadriSrinivasan SAMPATHKUMAR, Cupertino, CA (US); James Simon CHO, Mountain View, CA (US)

(21) Appl. No.: 14/920,651

(22) Filed: Oct. 22, 2015

(51) Int. Cl. H04W 8/24; H04L 12/26; H04L 12/861

(52) U.S. Cl. CPC H04W 8/245; H04L 49/90; H04L 43/0864

(57) ABSTRACT

Aspects of the present disclosure relate to a pre-fetching architecture and scheduler for multi-station APs. An example method generally includes fetching, from a plurality of host buffers, descriptive information for a set of packets based, at least in part, on an amount of descriptive information already cached for transmission to one or more target devices; using the fetched descriptive information to obtain the set of packets; and transmitting the set of packets to the one or more target devices.

### BACKGROUND

Field

Certain aspects of the present disclosure generally relate to wireless communications and, more particularly, to a scheduler for pre-fetching packet descriptors in an access point serving multiple stations.

Background

To address the issue of increasing bandwidth requirements demanded for wireless communications systems, different schemes are being developed to allow multiple user terminals to communicate with a single access point by sharing the channel resources while achieving high data throughputs. Multiple-input multiple-output (MIMO) technology represents one such approach that has recently emerged as a popular technique for next generation communication systems. MIMO technology has been adopted in several emerging wireless communications standards, such as the Institute of Electrical and Electronics Engineers (IEEE) 802.11 standard. The IEEE 802.11 standard denotes a set of Wireless Local Area Network (WLAN) air interface standards developed by the IEEE 802.11 committee for short-range communications (e.g., tens of meters to a few hundred meters).

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance such as higher throughput, greater reliability or both if the additional dimensionalities created by the multiple transmit and receive antennas are used.

### SUMMARY

Certain aspects of the present disclosure provide an apparatus for wireless communications. The apparatus generally includes a plurality of host buffers configured to store descriptive information for packets; a processing system configured to fetch, from the plurality of host buffers, descriptive information for a set of packets based at least in part on an amount of descriptive information already cached for transmission to one or more target devices, and use the fetched descriptive information to obtain the set of packets; one or more firmware queues configured to store the fetched descriptive information; and an interface configured to output the set of packets for transmission to the target devices.

Certain aspects of the present disclosure provide a method for wireless communications by an access point. The method generally includes fetching, from a plurality of host buffers, descriptive information for a set of packets based, at least in part, on an amount of descriptive information already cached for transmission to one or more target devices; using the fetched descriptive information to obtain the set of packets; and outputting the set of packets to the one or more target devices.

Certain aspects of the present disclosure provide an apparatus for wireless communications. The apparatus generally includes means for fetching, from a plurality of host buffers, descriptive information for a set of packets based, at least in part, on an amount of descriptive information already cached for transmission to one or more target devices; means for using the fetched descriptive information to obtain the set of packets; and means for outputting the set of packets to the one or more target devices.

Certain aspects of the present disclosure provide a computer readable medium. The computer readable medium includes instructions that, when executed, cause an apparatus to fetch, from a plurality of host buffers, descriptive information for a set of packets based at least in part on an amount of descriptive information already cached for transmission to one or more target devices; use the fetched descriptive information to obtain the set of packets; and output the set of packets for transmission to the target devices.

Certain aspects of the present disclosure provide a wireless station. The station generally includes at least one antenna; a processing system configured to fetch, from a plurality of host buffers to one or more firmware queues, descriptive information for a set of packets based at least in part on an amount of descriptive information already cached for transmission to one or more target devices; and use the fetched descriptive information to obtain the set of packets; and a transmitter for transmitting, via the at least one antenna, to the one or more target devices the obtained set of packets.

Various aspects also provide various apparatuses, program products, and devices (e.g., wireless stations, such as access points and other types of wireless devices) capable of performing the operations of the methods described above.

### BRIEF DESCRIPTION OF THE DRAWINGS

FIG. 1 illustrates a diagram of a wireless communications network in accordance with certain aspects of the present disclosure.

FIG. 2 illustrates a block diagram of an example access point and user terminals in accordance with certain aspects of the present disclosure.

FIG. 3 illustrates a block diagram of an example wireless device in accordance with certain aspects of the present disclosure.

FIG. 4 illustrates an example buffer queue architecture.

FIG. 5 illustrates example operations that may be performed by an access point to schedule packet descriptor pre-fetching, in accordance with certain aspects of the present disclosure.

FIG. 5A illustrates example means capable of performing the operations shown in FIG. 5.

FIG. 6 illustrates an example buffer queue architecture with per-station host buffers, in accordance with certain aspects of the present disclosure.

FIG. 7 illustrates example packet descriptor pre-fetching and transmission, in accordance with certain aspects of the present disclosure.

FIG. 8 illustrates example pre-fetching of packet descriptors, in accordance with certain aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects of the present disclosure provide techniques that may provide for selectively pre-fetching packet descriptors for host and firmware data structures dedicated to individual stations connected to an access point. By selectively pre-fetching packet descriptors in dedicated, per-station host and firmware data structures, an access point can avoid performance degradation (e.g., in terms of throughput) in situations where few packet descriptors are queued for some, but not all, stations served by the access point.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

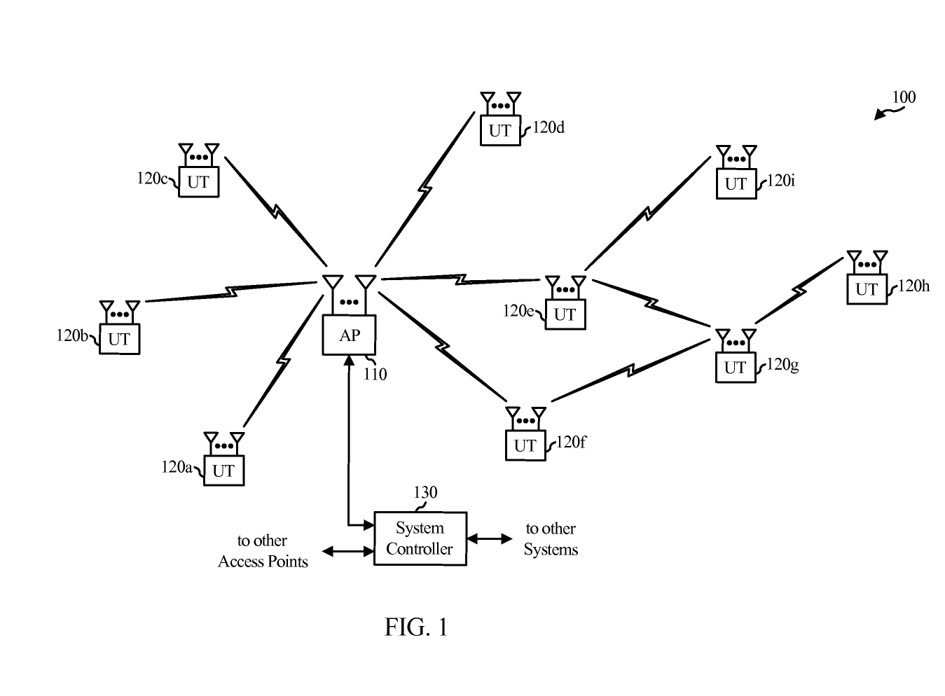

FIG. 1 illustrates a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The access point 110 and user terminals 120 employ multiple transmit and multiple receive antennas for data transmission on the downlink and uplink. For downlink MIMO transmissions, Nₐₚ antennas of the access point 110 represent the multiple-input (MI) for downlink transmissions, while a set of K selected user terminals 120 collectively represent the multiple-output (MO) portion of MIMO. Conversely, for uplink MIMO transmissions, the set of K user terminals represent the MI portion, while the Nₐₚ antennas of the access point 110 represent to MO portion. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

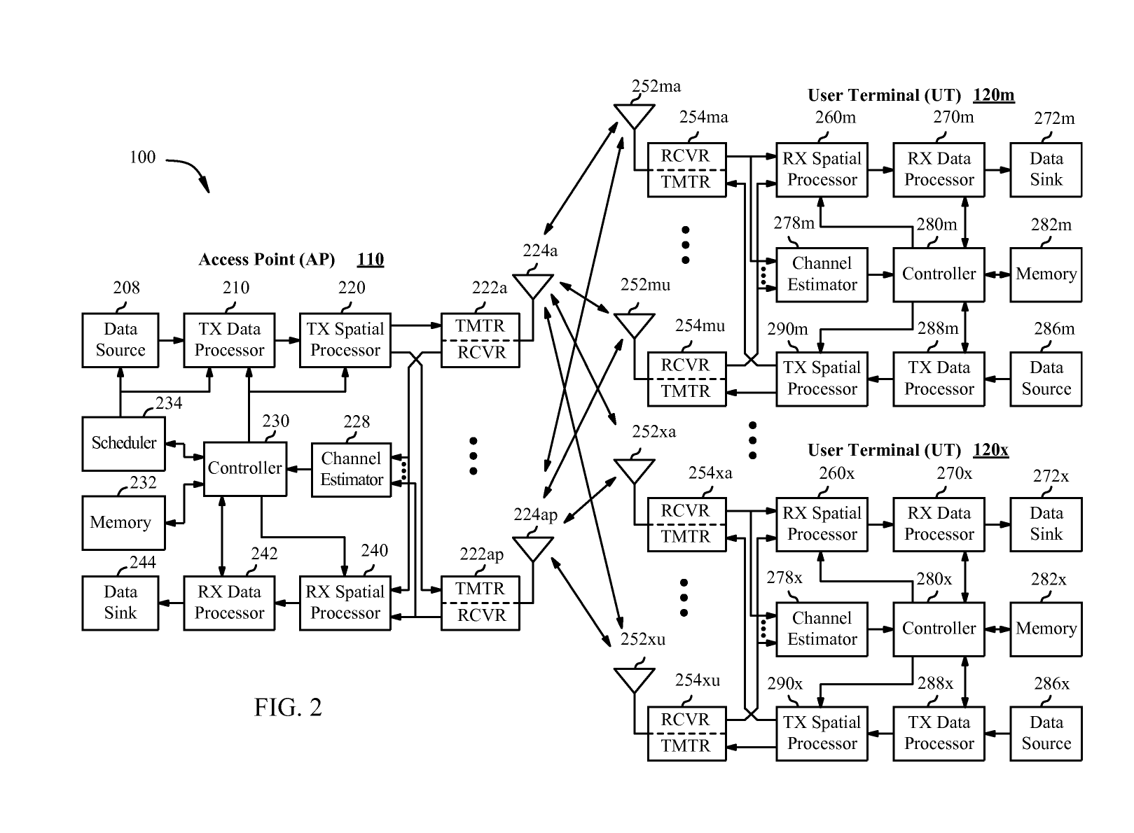

FIG. 2 illustrates a block diagram of access point 110 and two user terminals 120m and 120x in MIMO system 100. The access point 110 is equipped with Nₜ antennas 224a through 224t. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, and the subscript “up” denotes the uplink. For SDMA transmissions, Nᵤₚ user terminals simultaneously transmit on the uplink, while N_{dn} user terminals simultaneously are transmitted to on the downlink by the access point 110. Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

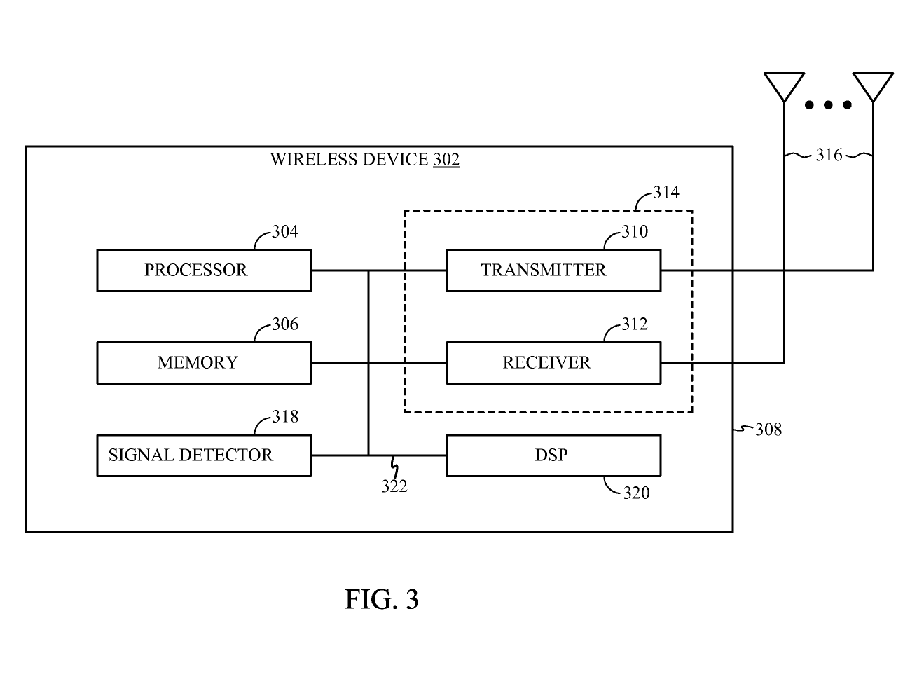

FIG. 3 illustrates various components that may be utilized in a wireless device 302 that may be employed within a wireless communication system (e.g., system 100 of FIG. 1). The wireless device 302 is an example of a device that may be configured to implement the various methods described herein. The wireless device 302 may be an access point 110 or a user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

### Pre-Fetch Architecture for Multi-STA Basic Service Set (BSS)

Certain aspects of the present disclosure provide techniques for using dedicated host buffer data structures for each of a plurality of stations served by an access point (AP) to transmit data packets from the AP to those stations.

In some cases, an AP may include a host buffer, a firmware buffer, and memory. Frames to be transmitted to one or more stations connected to the access point are generally stored in the memory. The host buffer may store descriptors, or pointers to frames to be transmitted, and the descriptors may be a memory address indicating a location of a specific frame in the memory.

According to certain aspects, the firmware buffer may include a plurality of queues, with each queue associated with a station served by the access point. In some cases, firmware memory may be limited. Thus, the firmware queues may store partial descriptors in an attempt to conserve memory space. As frames are transmitted to one or more stations, the firmware can remove the descriptors from the queues in the firmware buffer and retrieve other descriptors from the host buffer.

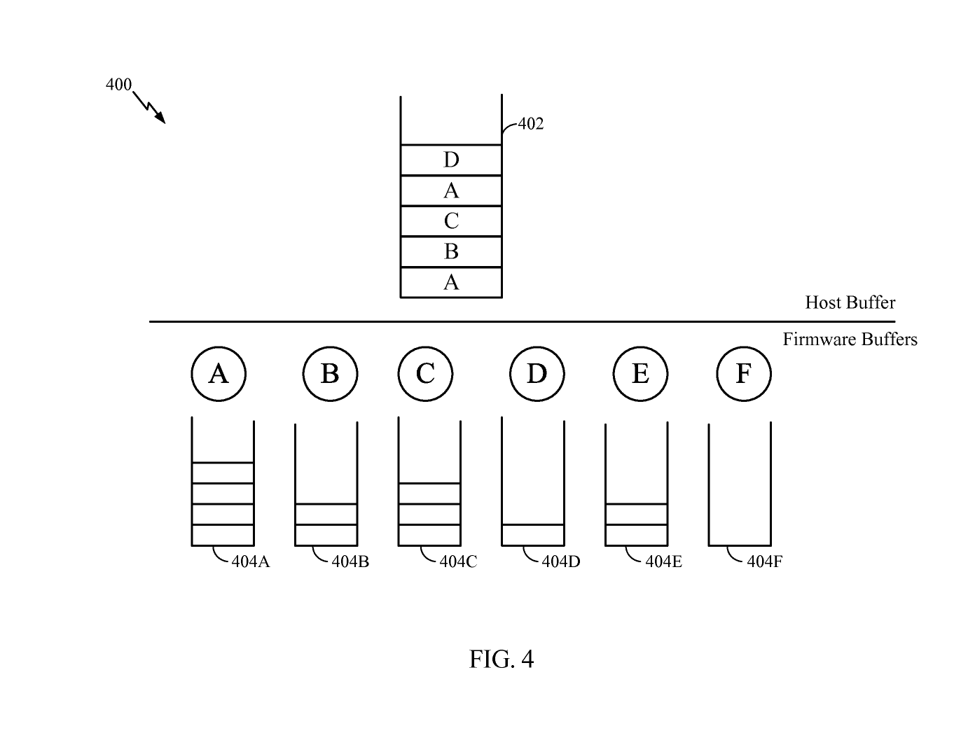

FIG. 4 illustrates an example host buffer and firmware buffer architecture 400 for an AP. As illustrated in FIG. 4, a single host buffer 402 stores packet descriptors pointing to frames to be transmitted to one or more stations served by the AP. The host buffer may be a first-in, first-out (FIFO) data structure, where frame descriptors added to the host buffer earlier (“first-in”) are transferred (“first-out”) to the appropriate firmware buffer 404 (i.e., the firmware buffer for a specific station) before frame descriptors added to the host buffer at a later point in time. According to certain aspects, the AP firmware can schedule a receiver for single-user transmissions from the AP or groups of receivers for multi-user transmissions from the AP and transmit frames to one or more stations from the corresponding firmware buffers for each station.

Because firmware memory may be limited, the firmware buffers for each station served by an AP may be relatively short (e.g., when an AP is serving multiple stations). In some cases, frame descriptors for some receivers may be blocked by other descriptors in the host buffer, which may further shorten the firmware buffers for certain receivers. For example, if transmissions for one station continually occupy a majority of a FIFO host buffer, the firmware buffers for the other stations served by the access point may not receive any descriptors or receive a comparatively small number of descriptors from the host buffer.

If an AP performs single user transmission to a target station and the descriptors in the firmware buffer for the target station are insufficient for a longer burst duration, the AP may only be able to use a short burst duration for transmissions to the target station. By using short burst durations, network throughput may be reduced. For multi-user transmissions, if there are not enough descriptors in one or more of the firmware buffers for the target stations, the AP may use a relatively short burst duration for transmissions to all of the target stations. In another case, the AP may pad transmissions to target stations with less data in the associated firmware buffers. In both cases, network throughput may be reduced, and in some cases, media access control (MAC) layer efficiency may be reduced.

To compensate for delays or latency in fetching descriptors for a long transmission (e.g., a latency value of about 8-12 ms to fetch an 8 ms, 3-station short interframe space (SIFS) burst transmission), the firmware buffers may store several pre-fetch commands Each pre-fetch command may correspond to one SIFS burst. Further, to avoid short burst durations resulting from the presence of an insufficient number of descriptors in a firmware buffer, a pre-fetch scheduler may be used to predict future transmissions and pre-fetch the appropriate descriptors for multiple stations served by the AP.

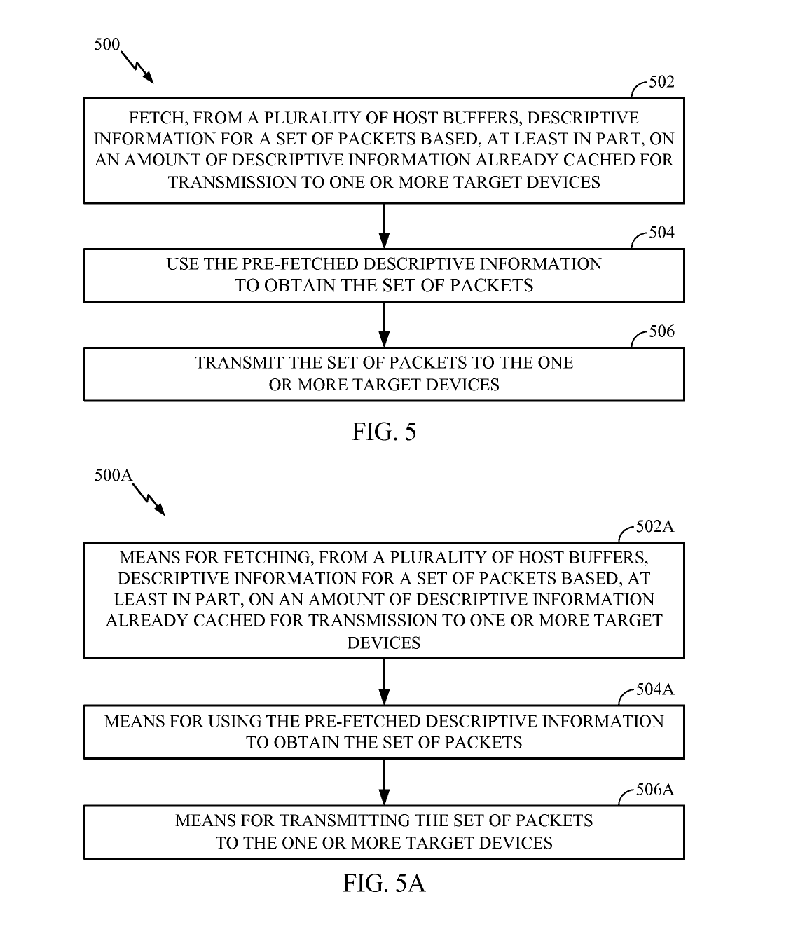

FIG. 5 illustrates example operations 500 that may be performed, for example, by an access point to pre-fetch and buffer descriptors for transmissions to a plurality of stations, according to aspects of the present disclosure.

Operations 500 begin, at 502, by fetching, from a plurality of host buffers, descriptive information for a set of packets. The fetched descriptive information may be stored in a plurality of firmware queues prior to transmitting the set of packets to the target devices. The descriptive information for the set of packets may be fetched based, at least in part, on an amount of information already cached for transmission to one or more target devices.

At 504, the access point uses the fetched descriptive information from the firmware queues to obtain the set of packets. At 506, the access point transmits the set of packets to the target devices.

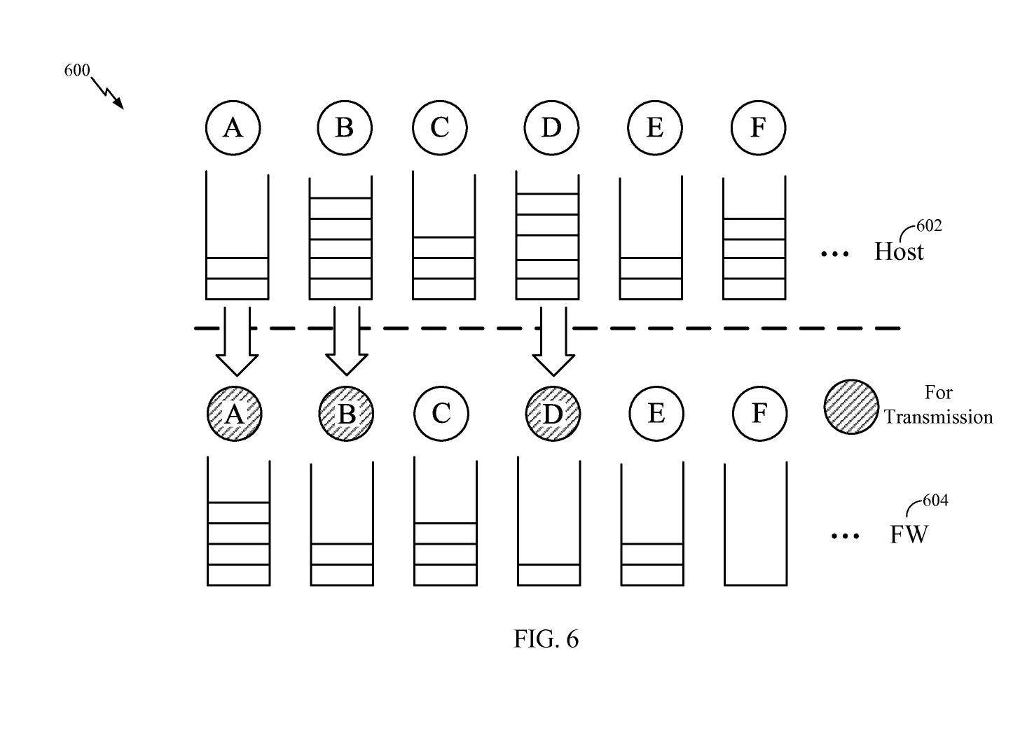

In some cases, as illustrated in FIG. 6, an access point architecture 600 may include a plurality of host buffers 602 and a plurality of firmware buffers 604 for each active station. Host buffers 602 may not be FIFO structures. Rather, the host buffers 602 may be configured to selectively pass descriptors to the appropriate firmware buffers 604 for stations that the AP will transmit to in the near future. As the firmware buffers 604 transmit out frames, firmware buffers 604 may be refilled from the corresponding host buffer. In some cases, a firmware buffer 604 may fetch descriptors from a corresponding host buffer 602. In other cases, host buffer 602 may push descriptors to the corresponding firmware buffer 604. The number of firmware buffers 604 may be based, at least in part, on a number of active stations. In some cases, the size of each firmware buffer 604 associated with a receiving station may be the same; in other cases, however, the size of each firmware buffer may be dynamically adjusted to account for an amount of traffic intended for each of the receiving stations.

Because descriptors need not be retrieved from host buffers 602 on a first-in, first-out basis, the firmware may use a scheduler (e.g., a scheduling algorithm) to schedule certain firmware buffers 604 to retrieve descriptors from the corresponding host buffer 602.

When the firmware schedules a firmware buffer 604 to retrieve descriptors from the corresponding host buffer 602, the scheduler may need to account for delays or latency in the fetch process. For example, processing a request for descriptors may entail a delay of 2-6 ms, while passing packet descriptors from the host buffer 602 to the firmware buffer 604 may entail a delay of 8-10 ms per descriptor. For 3-station MU transmissions with an 8 ms SIFS burst duration and a 2 ms burst, for example, the total size of the transmission may be 64 MAC physical data units (MPDUs) per station, per 2 ms burst, or about 768 MAC service data units (MSDUs). A total fetch delay (latency) for such a transmission may be about 8-12 ms. Additionally, descriptors should be pre-fetched before transmission to a target station begins. To compensate for processing delays and an amount of descriptors to be pre-fetched before transmission begins, pre-fetching may be scheduled based on an estimate for future transmission.

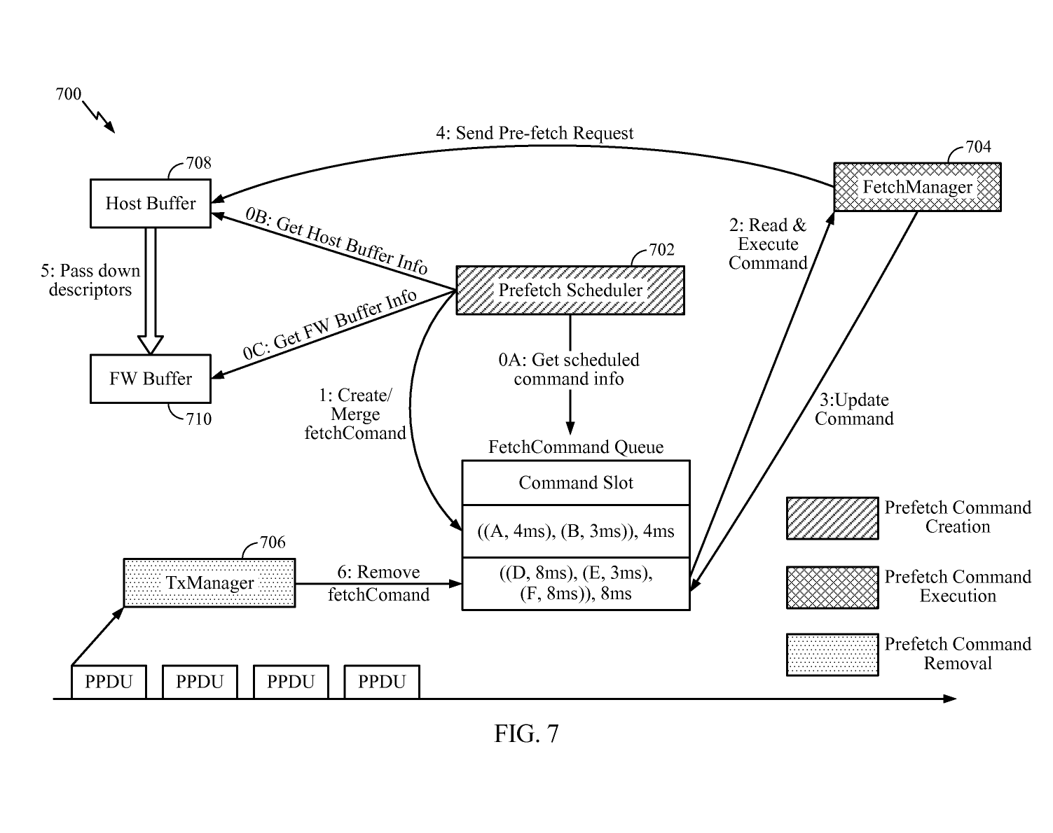

FIG. 7 illustrates an example AP architecture 700 and illustrates pre-fetching descriptors for transmission to a plurality of stations, according to aspects of the present disclosure. As illustrated, an access point may include a prefetch scheduler 702, fetch manager 704, a transmission manager 706, host buffer 708, and firmware buffer 710. As discussed above, host buffer 708 and firmware buffer 710 may each include a plurality of data structures, with each data structure corresponding to a station served by the AP. The pre-fetching is shown as a series of steps, enumerated from 0 to 6.

At steps 0A-0C, prefetch scheduler 702 retrieves the scheduled command information from a command queue of fetch commands, information about the host buffer 708, and information about the firmware buffer 710. The scheduled command information from the command queue may include information about pending fetch commands (e.g., a status of pending fetch commands) for scheduled transmissions to a receiving station (or groups of receiving stations) and a maximum SIFS burst duration for the group of stations.

The scheduled command information may also include, for example, the estimated transmission rate for the receiving station or group of stations and, if applicable, the amount of the transmission that has already been fetched. For example, the prefetch scheduler 702 uses information obtained from the host buffer 708 and firmware buffer 710 to determine which client(s) for which descriptors are to be fetched (e.g., based on an amount of descriptors remaining in a data structure for a particular station).

Based on the scheduled command information, host buffer information, and firmware buffer information, prefetch scheduler 702 creates a prefetch command (step 1) and sends the prefetch command to fetch manager 704. In some cases, a new prefetch command may be created by merging an existing prefetch command with additional information identifying new descriptors to fetch.

At step 2, the fetch manager 704 reads and executes the fetch command generated by the prefetch scheduler 702. As fetch manager 704 reads the commands, fetch manager 704 can update fetch commands (step 3) to reflect commands that have already been partially or wholly executed. After updating fetch commands as necessary, fetch manager 704 sends a pre-fetch request to a host buffer (step 4). The pre-fetch request generally indicates to the host buffers that a number of descriptors are to be passed from certain host buffers 708 to the corresponding firmware buffers 710 (step 5).

When transmission begins, the transmission manager 706 reads a fetch command to determine the packets to transmit during a SIFS burst and the one or more receiving stations for the SIFS burst. Once the transmission manager 706 begins a transmission specified by a fetch command, transmission manager 706 can remove the executed fetch command from the fetch command queue (step 6).

In some cases, the prefetching may be scheduled based on a timer. For example, the firmware may perform scheduling every millisecond to ensure that descriptors are pre-fetched and passed down from the host buffers to the corresponding firmware buffers before transmission begins.

In some cases, AP firmware may start scheduling pre-fetch operations if certain conditions are not met. For example, pre-fetch operations may begin if the command queue does not have enough entries, depending on the prefetch delay (e.g., latencies in performing prefetching) and SIFS burst duration, to transmit packets to one or more receiving stations. The minimum number of entries to be cached in the command queue may be represented by:

[fetchDelay/burstDuration]

For example, if the pre-fetch delay at the AP is 12 ms and the SIFS burst duration is 10 ms, the minimum number of command queue entries may be 2. For shorter burst durations, additional entries may be needed in the command queue to ensure that a sufficient number of commands have been scheduled to avoid delayed transmissions (or transmitting little to no data) to the one or more receiving stations.

In some cases, the total number of transmissions to be fetched in the command queue, measured by time, may be larger than the maximum fetch time. If the command queue has less data buffered than the amount of data that can be fetched from firmware in one fetch time period, the firmware may need to fetch additional descriptors to ensure that enough data is buffered for future transmission. For example, if the firmware is configured to fetch 6 ms of data (corresponding to roughly 3 PPDUs), but only 4 ms of data is buffered in the command queue (roughly 2 PPDUs), the firmware may need to prefetch at least 2 ms of data (roughly 1 PPDU).

If the command queue is sufficiently populated based on the prefetch delay and SIFS burst duration and the total transmission time to be fetched in the command queue is larger than the maximum fetch time, the scheduler need not take any additional action. At a later time (e.g., the next millisecond, based on a timer), the scheduler can examine the commands in the command queue again and determine, as described above, whether to schedule pre-fetch operations for one or more host and/or firmware buffers.

As discussed above, a prefetch command may include, for example, the burst duration for each member station in an MU group or the burst duration for a SU receiver, the transmission time to be fetched for each station in an MU group or for a SU receiver, and the delay between fetching a packet and arrival at a firmware buffer due to fetch delay. One scheduled entry in the command queue may denote a single future SIFS burst. In some cases, when a group is already scheduled in the command queue, the scheduler may increase the SIFS burst duration for a group as additional transmissions are scheduled until the burst duration for the group reaches the maximum SIFS burst duration.

When AP firmware begins scheduling prefetch commands, the AP firmware may obtain information needed for scheduling for each station. The information may include a transmission time (e.g., in milliseconds). To calculate a transmission time, the firmware can convert the number and size of the packets in the firmware and host buffers based on an estimated modulation and coding scheme (MCS) for a particular station. A total burst duration for a particular station may be generated based on the burst durations for the station for each command in the command queue.

In some cases, the burst duration may be calculated according to the following equation:

min(max(hostTxTime+FWTxTime−scheduledBurstDuration, 0), maxBurstDuration)

where hostTxTime represents the amount of time to fetch a descriptor from the host buffer, FWTxTime represents the amount of time to fetch a descriptor from the firmware buffer, and scheduledBurstDuration is, as discussed above, the total burst duration for a particular station.

After calculating the burst duration for each station, the AP schedules transmissions by choosing one or more stations for a future SIFS burst. For example, for MU transmissions, the AP may choose n stations (e.g., based on the number of simultaneous transmissions supported by the AP) with the longest burst durations to form an MU group. For SU transmission, the AP may schedule future transmissions for the station with the longest burst duration.

Based on the number of PPDUs to be transmitted in an MU SIFS burst, the AP may round up the burst duration. The SIFS burst may be transmitted without adding padding for any of the stations in the MU group. For example, when the maximum PPDU duration is set to 2 ms, and one station in a group has a burst of 3 ms, a maximum of two PPDUs may be transmitted. Thus, the AP may round up the burst duration to a maximum of 4 ms (2 PPDUs). In another example, where one SIFS burst may support a maximum of 4 PPDUs, with each PPDU having a duration of 2 ms, the maximum SIFS burst duration may be set to 8 ms (4 PPDU*2 ms). In an example MU group with three stations, each having a burst duration of 10ms, the burst duration may be rounded down to 8 ms to account for the maximum SIFS burst duration supported by the AP.

After calculating a burst duration, the AP calculates a transmission time to be fetched. The transmission time to be fetched may be represented by the equation:

max(burstDuration−FWTxTime−InFlightTxTime−AlreadyScheduledTxTime+successfulInTransmissionTxTime, 0)

In other words, the transmission time to be fetched may start with the calculated burst duration, with reductions for the amount of time represented by the amount of time to fetch descriptors from the firmware buffer (FWTxTime), the in-flight transmission time for pushing packet descriptors from the host buffer to the firmware buffer (InFlightTxTime), and the amount of time corresponding to packet descriptors already scheduled to be fetched (AlreadyScheduledTxTime). Additionally, the transmission time may be incremented by an estimated amount of time corresponding to packets that are currently in transmission from a firmware buffer to the receiving station and are expected to be received successfully.

After the AP calculates the transmission time to be fetched, the AP updates the command queue. For example, if no matching MU group of target devices or single user (SU) target device is scheduled in the command queue, a new command may be added to the command queue. As another example, if the same MU group or SU target device is scheduled in the command queue, but the existing commands were already fully executed (i.e., the entire transmission time has already been fetched), a new command may be added to the command queue. As still another example, if the same MU group or SU target device is scheduled in the command queue but the burst durations of existing commands have all reached the maximum burst duration, a new command may be added to the command queue.

In some cases, an existing MU group or single user may be scheduled in the command queue, the commands are not fully executed, and the burst durations for the existing commands have not reached the maximum burst duration. Thus, an existing command may be merged with a new command. In some cases, the most recent existing command for the MU group or single user may be merged with a new prefetching command. A new burst duration may be calculated based on:

min(oldBurstDuration+BurstDuration, MaxBurstDuration)

where oldBurstDuration is the burst duration for a station in the existing command and BurstDuration is the additional burst duration to be fetched, as calculated above. The transmission time to be fetched may be calculated using the new burst duration.

In some cases, prefetch command scheduling may drift from the real transmission timeline for various reasons. For example, the AP may schedule additional prefetch commands in advance of packet transmission, but due to transmission errors, additional prefetch commands in excess of that needed to provide for continuous transmission by the AP may be scheduled. In another example, as channel conditions change (e.g., packet errors rate decreases), the AP may schedule a number of packets for transmission based on a higher expected packet error rate (scheduling fewer packets for transmission than needed). For example, MCS estimation may be inaccurate, which may affect the accuracy of transmission time calculations described above. Further, the AP may not know how many packets are in transmission from the AP to one or more receiving stations and how many of those packets will be successfully received at the one or more receiving stations. To compensate for this drift, various mechanisms may be used to synchronize prefetch command scheduling and the real transmission timing

Because scheduling and transmission may occur at different times, the scheduler may not be able to predict when transmissions occur and how much time has elapsed since the AP last performed channel estimation for a station. In some cases, to avoid fetching fewer packets than needed, the AP may assume that the best MCS data would be used (e.g., the MCSs generated immediately after sounding). In some cases, an MCS array may be recorded for every PPDU in a SIFS burst immediately after sounding, and the recorded arrays may be used to estimate the MCS for each PPDU within a scheduled burst duration.

To account for packets in transmission, an AP may attempt to avoid scheduling prefetching commands for station already in communication with the AP. If the AP can find at least one station or group of stations with a burst duration equaling the maximum burst duration, the AP can schedule prefetching for that station or group of stations instead of stations or groups of stations that are already communicating with the AP.

If, however, the AP cannot avoid scheduling prefetching for stations that already in communication with the AP, the AP may estimate a packet error rate for each station and use the estimated packet error rate to determine the stations for which prefetching operations may be performed. For example, after every PPDU, the AP may update a total number of packets in transmission by decrementing the total number of packets in transmission by the number of successfully delivered packets.

Additionally, the AP can record the average packet error rate for each station after every transmission. Based on the estimated packet error rate, the AP can adjust the amount of descriptors to be prefetched, as discussed above (e.g., based on an estimated number of in-transit packets that will be successfully received by the receiving station). In some cases, the estimated number of successfully received packets can be calculated based on the packet error rate and the MCS of the current transmission.

In some cases, the AP may maintain a counter of the number of stations (or target devices) that are being served by the AP (e.g., a number of stations connected to the AP, or a number of connected stations that have transmitted data to or received data from the AP during a set time period). When the counter indicates that AP is serving a small number of stations (e.g., serving a number of stations equal to or below a threshold number of stations), the AP can switch from fetching descriptors at the firmware buffers to pushing descriptors from the host buffers to the firmware buffers (e.g., at a host buffer, transferring descriptors to the firmware buffers). The AP may divide the firmware buffer into n positions, where n is the number of stations served by the AP. The host buffers may monitor for vacancies in the corresponding firmware buffers. When a vacancy occurs, the AP may push descriptors from the host buffer to the corresponding firmware buffer. Because the host buffers push descriptors to the corresponding firmware buffers, the AP need not schedule prefetching for the firmware buffers. The firmware may select stations for transmission based on the depth of the firmware queues for each station.

Because of the asynchronous nature of pre-fetching scheduling and transmission, the firmware buffer may be occupied by an accumulation of residual packet descriptors. To handle accumulated packet descriptors, the AP can check if the firmware buffers are full when the AP attempts to schedule prefetching operations. If the firmware buffers are full, the AP can disable the prefetch scheduler and select a single receiver or a group of receivers based on firmware queue depth. When the number of descriptors in the firmware buffers drop to or below a threshold value, the prefetch scheduler may be re-enabled. In some cases, the threshold value may be set to ensure that when the AP transmits N packets, the AP can finish prefetching packets for at least one SIFS burst.

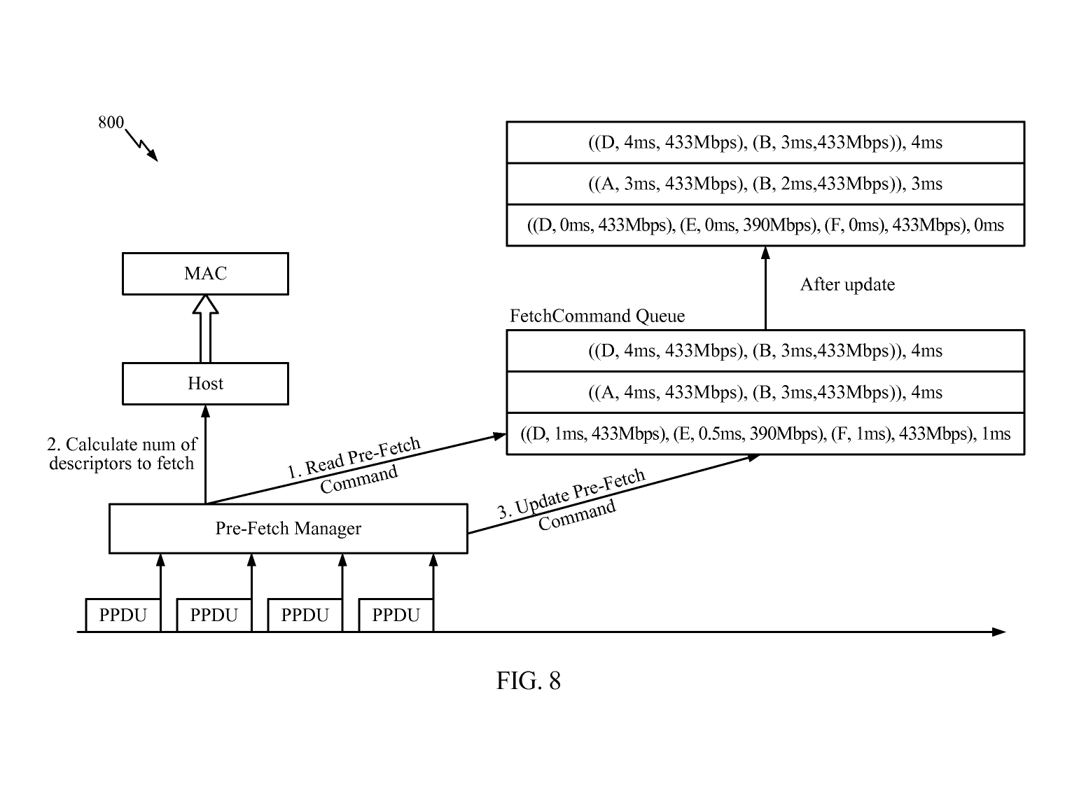

The prefetch manager may execute the scheduled prefetch commands. As illustrated in FIG. 8, in some cases, the prefetch manager may maintain a pointer to one entry in the command queue. For each prefetch command, the prefetch manager may start executing the command referenced by the pointer, and when the command is fully executed (i.e., all the required transmission time has been fetched), the prefetch manager may mark the current entry as completed and moves the pointer to the next entry in the command queue.

As discussed above, due to packet error rates or collisions, not every fetched packet may be successfully sent in a single transmission, and residual descriptors may be left in the firmware buffers. Additionally, if too many packets are prefetched at a given time, residual packets may be left in the firmware buffers and may block future prefetches for other stations. To avoid an accumulation of residual packets in the firmware buffers, the prefetch manager may keep an inflow amount of descriptors arriving in the firmware buffers the same or similar as an outflow amount of packets transmitted to one or more stations.

Prefetching generally may be scheduled for the end of each PPDU transmission. In some cases, the prefetched transmission time may be set as the maximum PPDU duration. For prefetching commands with short transmission times, the prefetch manager may execute several prefetching commands during a single prefetch operation. Meanwhile, for prefetching commands with long transmission times, execution of the prefetching command may be spread among multiple prefetch operations, and the prefetch manager may update the prefetching command after every operation to mark the amount of time that has been prefetched.

Each time the prefetch manager sends a fetch request to the host firmware, the host may take an amount of time, PROCESS_DELAY, to process the request. For each packet descriptor, there may be a delay, PASSING_DELAY, for passing a descriptor from a host buffer to a firmware buffer. A fetch delay may be calculated as PROCESS_DELAY+PASSING_DELAY*number of descriptors to fetch. Because SIFS bursts may be stopped due to late packet arrival, a sufficient number of packet descriptors should be stored in the firmware buffers before a SIFS burst. In one case, a sufficient number of packet descriptors may be all fetched packet descriptors. However, depending on the fetch delay, not all packets need be stored in the firmware buffers before a SIFS burst, as the remainder of the packets transmitted in the SIFS burst may arrive in the firmware buffers before transmission.

In some cases, the PPDU duration may be shorter than the maximum supported PPDU duration, so descriptors may accumulate in the firmware buffers. As described above, when the firmware buffers are filled, the firmware buffers may discontinue fetching descriptors from the host buffers, and the host buffers may push packet descriptors to the firmware buffers as necessary until accumulated descriptors are removed from the firmware buffers.

To fetch N descriptors, the prefetch manager may execute K commands. The total delay to fetch the N descriptors may be PROCESSING_DELAY*K+PASSING_DELAY*N. The total delay increases as the number of commands increases. Over time, the processing delay time and the number of descriptors to be fetched may change, and over time, not enough packet descriptors may have arrived in a firmware buffer at the scheduled beginning of a SIFS burst. When too few packet descriptors are present in a firmware buffer, the beginning of the SIFS burst for one or more receiving stations may be delayed.

To compensate for processing and fetch delays, when the AP finds that too few descriptors have been fetched at the beginning of a SIFS period, the AP may increase the amount of time that can be fetched during a single prefetching operation by Δms. When the total number of fetched packet descriptors reaches a threshold value (e.g., in terms of a number of milliseconds of packet data to be transmitted) before the AP can transmit the prefetched packets, the AP can decrease the amount of time that can be fetched during a single prefetching operation by Δms. Additionally, when the AP finds that one or more firmware buffers are full, the AP can decrease the amount of time that can be fetched during a single prefetching operation by Δms.

In some cases, descriptors may be unfetched from the firmware buffers to the host buffers. For example, when one or more firmware buffers are completely filled, some descriptors (e.g., descriptors associated with packets that are to be transmitted later) may be unfetched from the firmware buffers. In another case, if a firmware buffer only has a few packet descriptors, the descriptors may be unfetched to the host buffers such that transmissions to one or more stations may be performed using a longer burst duration (with a correspondingly higher throughput).

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 500 illustrated in FIG. 5 may correspond to means 500A illustrated in FIGS. 5A.

For example, means for transmitting may comprise a transmitter, such as the transmitter unit 222 of the access point 110 illustrated in FIG. 2, the transmitter unit 254 of the user terminal 120 depicted in FIG. 2, or the transmitter 310 of the wireless device 302 shown in FIG. 3. Means for receiving may comprise a receiver, such as the receiver unit 222 of the access point 110 illustrated in FIG. 2, the receiver unit 254 of the user terminal 120 depicted in FIG. 2, or the receiver 312 of the wireless device 302 shown in FIG. 3. Means for fetching, means for using, means for obtaining, means for unfetching, means for storing, means for generating, means for maintaining, means for updating, means for adjusting, and/or means for discontinuing may comprise a processing system, which may include one or more processors, such as the RX data processor 270 and/or the controller 280 of the user terminal 120 or the RX data processor 242 and/or the controller 230 of the access point 110 illustrated in FIG. 2. The processing system may also include a correlator.

Further, in some cases, rather than actually transmit a subframe (or other structure), an entity (e.g., a processor) may output such a structure via a transmit interface to another entity (e.g., an RF front end or modem) for transmission. Similarly, rather than actually receive a subframe (or other structure), an entity (e.g., a processor) may receive such a structure from another entity (e.g., from an RF front end or modem) via a receive interface. For example, the receive interface may include a bus interface or other type interface.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM, or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications, comprising:
a plurality of host buffers configured to store descriptive information for packets;
a processing system configured to:
fetch, from the plurality of host buffers, descriptive information for a set of packets based at least in part on an amount of descriptive information already cached for transmission to one or more target devices, and
use the fetched descriptive information to obtain the set of packets;
one or more firmware queues configured to store the fetched descriptive information; and
an interface configured to output the set of packets for transmission to the target devices.

2. The apparatus of claim 1, wherein an amount of descriptive information to be fetched is based, at least in part, on a latency value associated with the fetch.

3. The apparatus of claim 1, wherein a number of the one or more firmware queues is based, at least in part, on a number of active stations.

4. The apparatus of claim 1, wherein the processing system is further configured to:
fetch, from one or more of the firmware queues, at least some of the descriptive information; and
store the at least some of the descriptive information in one or more of the plurality of host buffers.

5. The apparatus of claim 1, wherein the processing system is further configured to dynamically adjust a size of the one or more firmware queues.

6. The apparatus of claim 1, wherein the processing system is configured to generate fetch commands to fetch the descriptive information from the plurality of host buffers, and wherein each fetch command comprises at least one of:
a burst duration for each target device in a multi-user (MU) group or a single user (SU) target device;
a transmission time to be fetched for each member of an MU group or the SU target device; or
an in-flight transmission time for descriptive information that has been fetched but has not arrived in the firmware queues for each member of an MU group or the SU target device.

7. The apparatus of claim 6, wherein the processing system is further configured to:
maintain a status of pending fetch commands in a queue of fetch commands; and
update the status of the fetch commands based on at least a number of packets in the host buffer and an amount of time remaining to be buffered in one or more of the firmware queues.

8. The apparatus of claim 1, wherein the processing system is configured to dynamically adjust an amount of descriptive information to fetch based on at least one of:
one or more modulation and coding schemes used for transmission to the target devices;
a packet error rate for transmission to the target devices; or
a number of packets currently in transmission to one or more target devices.

9. The apparatus of claim 1, wherein the packets are output for an MU multiple-input multiple-output (MIMO) transmission to the target devices.

10. The apparatus of claim 1, wherein the processing system is further configured to:
discontinue fetching descriptive information from the host buffers and push descriptive information from the host buffers to the firmware queues, if a number of target devices served by the apparatus is equal to or below a threshold value.

11. A method for wireless communications, comprising:
fetching, from a plurality of host buffers, descriptive information for a set of packets based at least in part on an amount of descriptive information already cached for transmission to one or more target devices;
using the fetched descriptive information to obtain the set of packets; and
outputting the set of packets for transmission to the target devices.

12. The method of claim 11, wherein an amount of descriptive information to be fetched is based, at least in part, on a latency value associated with the fetch.

13. The method of claim 11, wherein a number of the one or more firmware queues is based, at least in part, on a number of active stations.

14. The method of claim 11, further comprising:
fetching, from one or more of the firmware queues, at least some of the descriptive information; and
storing the at least some of the descriptive information in one or more of the plurality of host buffers.

15. The method of claim 11, wherein a size of the one or more firmware queues is dynamically adjusted.

16. The method of claim 11, further comprising:
generating fetch commands to fetch the descriptive information from the plurality of host buffers, wherein each fetch command comprises at least one of:
a burst duration for each target device in a multi-user (MU) group or a single user (SU) target device;
a transmission time to be fetched for each member of an MU group or the SU target device; or
an in-flight transmission time for descriptive information that has been fetched but has not arrived in the firmware queues for each member of an MU group or the SU target device.

17. The method of claim 16, further comprising:
maintaining a status of pending fetch commands in a queue of fetch commands; and
updating the status of the fetch commands based on at least a number of packets in the host buffer and an amount of time remaining to be buffered in one or more of the firmware queues.

18. The method of claim 11, further comprising:
dynamically adjusting an amount of descriptive information to fetch based on at least one of:
one or more modulation and coding schemes used for transmission to the target devices;
a packet error rate for transmission to the target devices; or
a number of packets currently in transmission to one or more target devices.

19. The method of claim 11, wherein the packets are output for an MU multiple-input multiple-output (MIMO) transmission to the target devices.

20. The method of claim 11, further comprising:
discontinuing fetching descriptive information from the host buffers to the firmware queues and pushing descriptive information from the host buffers to the firmware queues, if a number of target devices served by an AP is equal to or below a threshold value.

21. A apparatus for wireless communications, comprising:
means for fetching, from a plurality of host buffers, descriptive information for a set of packets based at least in part on an amount of descriptive information already cached for transmission to one or more target devices;
means for using the fetched descriptive information to obtain the set of packets; and
means for outputting the set of packets for transmission to the target devices.

22. The apparatus of claim 21, wherein an amount of descriptive information to be fetched is based, at least in part, on a latency value associated with the fetch.

23. The apparatus of claim 21, wherein a number of the one or more firmware queues is based, at least in part, on a number of active stations.

24. The apparatus of claim 21, further comprising:
means for fetching, from one or more of the firmware queues, at least some of the descriptive information; and
means for storing the at least some of the descriptive information in one or more of the plurality of host buffers.

25. The apparatus of claim 21, wherein a size of the one or more firmware queues is dynamically adjusted.

26. The apparatus of claim 21, further comprising:
means for generating fetch commands to fetch the descriptive information from the plurality of host buffers, wherein each fetch command comprises at least one of:
a burst duration for each target device in a multi-user (MU) group or a single user (SU) target device;
a transmission time to be fetched for each member of an MU group or the SU target device; or
an in-flight transmission time for descriptive information that has been fetched but has not arrived in the firmware queues for each member of an MU group or the SU target device.

27. The apparatus of claim 26, further comprising:
means for maintaining a status of pending fetch commands in a queue of fetch commands; and
means for updating the status of the fetch commands based on at least a number of packets in the host buffer and an amount of time remaining to be buffered in one or more of the firmware queues.

28. The apparatus of claim 21, further comprising:
means for dynamically adjusting an amount of descriptive information to fetch based on at least one of:
one or more modulation and coding schemes used for transmission to the target devices;
a packet error rate for transmission to the target devices; or
a number of packets currently in transmission to one or more target devices.

29. The apparatus of claim 21, wherein the packets are output for an MU multiple-input multiple-output (MIMO) transmission to the target devices.

30. The apparatus of claim 21, further comprising:
means for discontinuing fetching descriptive information from the host buffers to the firmware queues and pushing descriptive information from the host buffers to the firmware queues, if a number of target devices served by the apparatus is equal to or below a threshold value.

31. A non-transitory computer readable medium comprising instructions that, when executed, cause an apparatus to:
fetch, from a plurality of host buffers, descriptive information for a set of packets based at least in part on an amount of descriptive information already cached for transmission to one or more target devices;
use the fetched descriptive information to obtain the set of packets; and
output the set of packets for transmission to the target devices.

32. A wireless station, comprising:
a processing system configured to:
fetch, from a plurality of host buffers, descriptive information for a set of packets based at least in part on an amount of descriptive information already cached for transmission to one or more target devices; and
use the fetched descriptive information to obtain the set of packets; and
a transmitter for transmitting the set of packets to the target devices.
